(19) United States
(12) Patent Application Publication
(10) Pub. No.: US 2002/0118209 A1
(43) Pub. Date: Aug. 29, 2002

(54) Computer program product for introducing painting effects into a digitized photographic image

(76) Inventor: Steve H.L. Hylen, Roxbury, CT (US)

Correspondence Address: DARBY & DARBY P.C., 805 Third Avenue, New York, NY, 10022, US

(21) Appl. No.: 09/877,849

(22) Filed: Jun. 8, 2001

Related U.S. Application Data
(63) Continuation of application No. 09/664,230, filed on Sep. 18, 2000, now abandoned.
(60) Provisional application No. 60/155,172, filed on Sep. 21, 1999.

(51) Int. Cl. G06K 9/00

(52) U.S. Cl. 345/582

(57) ABSTRACT

The present invention involves a method for applying “painting” effects to a digitized image. A first method includes the step of creating a bitmap from an inputted digitized image wherein color values are assigned to each pixel in the image. The method then compares the color values of each pixel in the bitmap and determines “pixel-commonality” which defines “working regions”. The method then applies a predetermined texture to each working region from a database of textures. The particular texture selected is dependent on the particular artist or painting style chosen by the user. After the method displays the altered image (the image having the applied textures), the user may decide whether to save the altered image, or to have the method “re-paint” the original image. The method can “re-paint” the image by automatically changing predetermined parameters or default settings used to define working regions and/or the type and intensity of the applied textures.

Other methods of the invention, apply textures according to measured areas of the working regions, selected foreground working regions, or edge regions.

This patent application claims priority of U.S. provisional patent application serial no. 60/155,172, filed Sep. 21, 1999, entitled: Computer Program Product for Introducing Painting Effects into a Digitized Photographic Image. This provisional patent application is hereby incorporated by reference.

### BACKGROUND OF THE INVENTION

a) Field of the Invention

This invention relates generally to the field of digital imaging using a computer and, more particularly, to computer-aided digital imaging methods which introduce texture and special effects to digital images.

b) Description of Related Art

Photography, like any other art, is a form of communication. Traditionally, the photographer uses a camera to record an image onto silver-emulsion film. The resulting recorded image is a showing of the photographer's interpretation of the real world—a kind of blend between reality and imagination. Today's advances in computer-aided digital imaging have introduced a powerful new art medium which offers pixel-manipulating tools and special effects and which enables the “digital artist” or computer graphic artist to introduce various effects to an inputted photographic image, or create photo-real images completely from his or her imagination.

Photographs, drawings, and other planar art work may now be easily converted from the analog real world into the digitized computer world by simply scanning the art work into a computer using an appropriate scanner. During the conversion process, the image is divided into a rectangular grid or array made up of picture elements called pixels. Each pixel, by definition is a single solid color throughout.

Once stored in the digital format, the color value of each pixel (RGB components 1-255) of the inputted image may be changed to any different value to effectively alter the digitized image, according to the imagination of the computer graphic artist. The resulting manipulated image is called digital art.

There are several well known digital imaging software programs commercially available today. Among these programs is one called PhotoShop® available by Adobe Systems® Inc. of Mountain View, Calif. PhotoShop® is specifically designed to manipulate and alter digitized photographic images and offers a variety of special effects “filters” including blurring, diffusing, embossing, extruding, fragmenting, lens-flaring, pointillizing, solarizing, tilting, crystalizing, faceting, rippling, shearing, spherizing, as well as introducing mosaic patterns, twirling effects, wave effects and zigzaging. Unfortunately, the downside to offering so many image effects is that the PhotoShop® program becomes very complex and is difficult to use by all but the trained artisan. In addition to the standard PhotoShop® program, many companies including Adobe Systems, Inc. offer plugins and other supplemental software which may be used in combination with the main PhotoShop® program to offer even more special effects, such as magnification, crazing, and droplet effects.

In using the PhotoShop® program, a graphic artist usually begins by downloading or otherwise inputting a picture image, perhaps by downloading a picture from the computer's hard drive, a memory disc, from the Internet, directly from a digital camera, or scanning in a photograph or other planar art work using an electronic scanner. Once the photograph, for example, is digitized and loaded within the computer's hard drive, the pixels making up the photograph may be manipulated and altered either individually, or in selective groups. The graphic artist may use a mouse selector and a “lasso” function of PhotoShop® to manually trace a particular feature of the picture, such as a woman's hat. PhotoShop® also provides a feature called “a magic wand” or “wanding” for automatically locating pixels that have a common color shade (i.e., pixels that have color values that are within a range of color components). The level of precision (or how narrow the range of color commonality is) may be controlled by the graphic artist or program user.

Once an object of the image, such as “a hat” has been selected, either by using the lasso or the magic wand features of the PhotoShop® program, the selected pixels making up the hat, in this example may be altered in a desired manner to introduce any of a variety of effects, such as a uniform color change or introducing a mosaic pattern or texture. The resulting “hat” pixels may be altered without affecting the pixels of the remaining photographic image, i.e., those located outside of the selected “hat” region. Once the changes to the hat are complete, the graphic artist may then select another element or feature of the photographic image and change those groups of pixels in a similar manner until the digitized artwork is complete.

Unfortunately, while using PhotoShop®, the graphic artist must manually select each object within the image using either the “lasso” feature or the “magic wand” feature, and then manually select an appropriate texture for each selected region. The selection procedure can be time consuming and tedious because commonly, any photograph may include many elements which would be considered different “regions”. During the effects procedure, each of these elements would have to be individually selected using the mouse, prior to a texture or an effect being applied. Often, the different elements of a photograph are complex in shape and require great skill to trace in order to accurately select the particular region.

A professional graphic artist would have little difficulty using PhotoShop® to alter selected regions of a photograph. Regardless of the user's skill, however, the time consuming region selection procedure can not be avoided.

Owing in part to the complexity and cost of digital imaging software programs, such as PhotoShop®, the average photographer is discouraged from experiencing this new art medium of graphically manipulating photographs. The digital imaging software programs are very expensive and require intensive training before a user can comfortably utilize the program's features.

Accordingly, there is a need for a digital imaging software program to automatically perform complex pixel manipulations to an inputted photographic image. There is also a need for a simple program that can quickly and easily modify a photographic image to one that appears to have been painted - effectively creating paintings from photographs.

It is an object of the present invention to provide a digital imaging method which overcomes the above-described deficiencies of the prior art.

It is another object of the present invention to provide a user-friendly digital imaging method that automatically introduces electronic texture to different regions of a digitized photographic image or a digital image.

It is yet another object of the present invention to provide a user-friendly digital imaging method that is inexpensive to purchase and easy to use.

It is yet another object of the present invention to provide a user-friendly digital imaging method that may be downloaded over the Internet.

It is yet another object of the present invention to provide a user-friendly digital imaging method that allows a user to create a digitized image at a local site and thereafter transmit the digitized image data over the Internet to a remote site where the image data may be printed onto a tangible medium.

It is yet another object of the invention to provide an electronic scanner which includes an internal processor and pre-loaded digital imaging software including the present method.

It is yet another object of the invention to provide a digital camera which includes an internal processor and pre-loaded digital imaging software including the present method.

It is yet another object of the invention to provide a user-friendly digital imaging method which automatically selects various working regions within a digitized image and thereafter automatically applies a predetermined texture or effect to each selected working region, according to predetermined criteria.

It is another object of the invention to provide a method which automatically alters the pixels of a digitized photographic image to mimic the characteristics of a painting.

It is another object of the invention to provide a method which automatically alters the pixels of a digitized photographic image to mimic the characteristics of a painting according to the particular style of painting of a famous painter or period of paintings.

### SUMMARY OF THE INVENTION

The present invention involves a method for applying “painting” effects to a digitized image. A first method includes the step of creating a bitmap from an inputted digitized image wherein color values (or gray scale values in the case of black and white images—hereinafter collectively referred to as “color values”) are assigned to each pixel in the image. The method then compares the color values of each pixel in the bitmap and determines “pixel-commonality” which defines “working regions”. The method then applies a predetermined texture to each working region from a database of textures. The particular texture selected is dependent on the particular artist or painting style chosen by the user. After the method displays the altered image (the image having the applied textures), the user may decide whether to save the altered image, or to have the method “re-paint” the original image. The method can “re-paint” the image by automatically changing predetermined parameters or default settings used to define working regions and/or the type and intensity of the applied textures.

Another method of the invention is similar to the above-described method, except that an additional step of measuring the area of each working region is performed just after the working regions have been defined. After the areas of each working region are determined, the method here applies a predetermined texture to each working region according to their measured area. As before, the altered image is displayed and selectively printed, and the user has an opportunity to select as an input a particular artist or painting era.

A third method of the invention includes the step of creating a bitmap from an inputted digitized image wherein color values are assigned to each pixel in the image. This method then compares the color values of each pixel in the bitmap and determines “pixel-commonality” which defines “working regions”. The method then highlights each defined working region and displays the altered image (the image having the highlighted working regions) to the user. The user may input a selection of one or more working regions which all make up a particular part of the image, such as the foreground of the image. The user may again also input a selected artist or painting era. The method here then applies a predetermined texture to each working region from a database of textures. The particular texture selected is dependent on the particular artist or painting style chosen by the user and the selected foreground working regions. After the method displays the altered image (the image having the applied textures), the image may be saved in an appropriate memory and printed out.

A fourth method of the invention includes the step of creating a bitmap from an inputted digitized image wherein color values are assigned to each pixel in the image. This method then compares the color values of each pixel in the bitmap and determines “pixel-commonality” which defines “working regions”. The method then uses the bitmap to define “edge regions” which are located a predetermined distance from the edges of each working region. After the user may input a selected artist or painting era, the method here then applies a predetermined texture to each working region from a database of textures. The particular texture selected is dependent on the particular artist or painting style chosen by the user. The method then applies a paint-stroke texture to each edge region according to the direction and location of the edge of each working region. After the method displays the altered image (the image having the applied textures), the image may be saved in an appropriate memory and printed out.

### BRIEF DESCRIPTION OF THE DRAWINGS

FIG. 1 illustrates a typical computer system that may be used to practice the present invention, including computer data-input peripherals, memory devices, output peripherals, and various tangible image formats;

FIG. 2 is an exemplary original digital image of a woman jogging in the foreground and showing trees and plants in the midground, foreground, and background;

FIG. 3 is an exemplary altered digital image of the image of FIG. 2, showing applied textures to various working regions of the image;

FIG. 4 is a flow diagram describing an exemplary digital imaging process according to one method of the present invention;

FIG. 5 is a flow diagram describing an exemplary digital imaging process according to a second method of the present invention;

FIG. 6 is a flow diagram describing an exemplary digital imaging process according to a third method of the present invention;

FIG. 7 is a digital image of a woman's head and upper body, showing examples of “working regions” and “edge regions”, according to the invention;

FIG. 8 is a flow diagram describing an exemplary digital imaging process according to a fourth method of the invention; and

FIGS. 9 and 10 are each an exemplary illustration of a computer screen of a computer running the present digital imaging process, wherein an original digital image may be compare with a first altered image and thereafter replaced with a second altered image, as controlled by the user.

### DETAILED DESCRIPTION OF THE PREFERRED EMBODIMENT

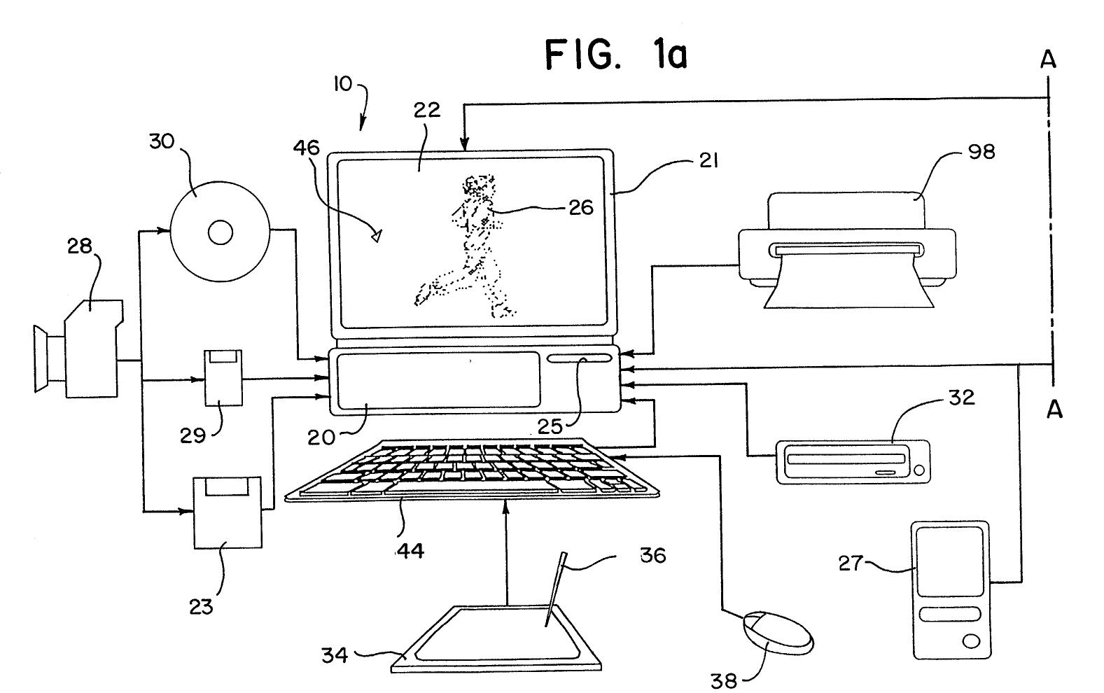

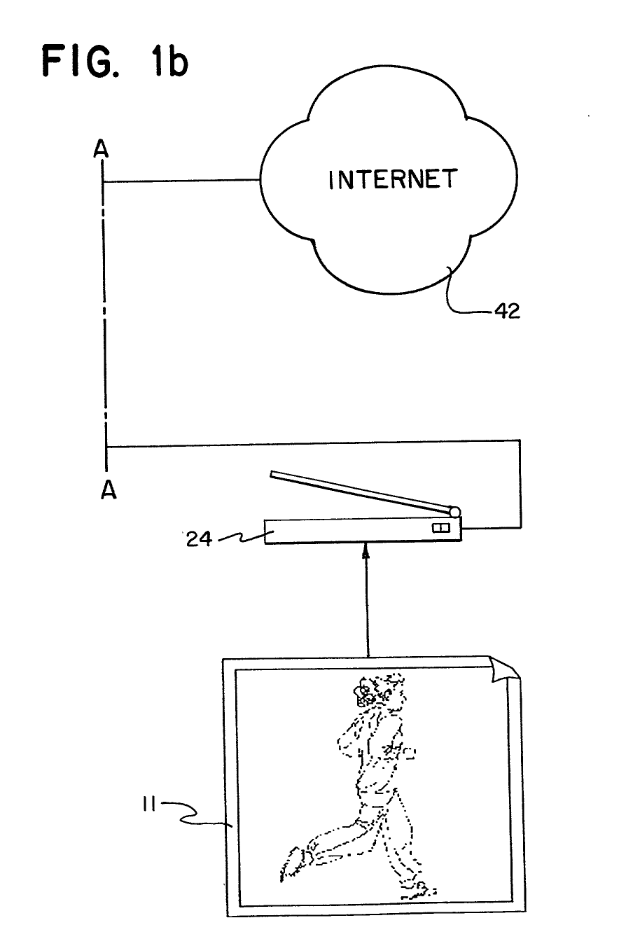

Referring to FIG. 1, there is illustrated a computer system 10 which may be used for implementing the present invention. Although the computer system 10 is shown utilizing a still photograph, the present invention is not limited to still photographs, but may also be used on moving pictures, transparencies, drawings or paintings or any other type of image (hereinafter called a tangible image 11) that may be digitized into a computer, as is understood by those skilled in the art. Computer system 10 includes a microprocessor based unit 20 and a display 21 having a screen 22. Microprocessor-based unit 20 is adapted to receive and process software programs as instructions to performing various processing functions. Software programs may be received by and instruct the microprocessor based unit 20 either from a magnetic storage medium (floppy disc or diskette) 23 which is typically inserted directly into the microprocessor based unit 20 in an appropriate disc reader or drive 25, or the software may be preprogrammed into ROM memory (e.g., an internal hard drive) or even RAM memory located within or connected to the microprocessor based unit 20.

A scanner 24 is electrically connected to the microprocessor based unit 20 for digitizing any tangible image 11 (a photograph in FIG. 1, of a person jogging represents such a tangible image 11 for the purpose of describing the present invention) placed on the scanner. As discussed above, scanner 24 may accept different types of planar image mediums including, photographs, drawings, paintings. A transparency-type scanner 27 may be used to input transparencies (e.g., slides), and negatives. Both scanners 24 and 27 may operate in a conventional manner as known by those skilled in the art to convert tangible image 11 (such as the photograph of the person jogging) into a digitized image 26 (which is shown in FIG. 1 being displayed on screen 22 of monitor 21).

As is further discussed below, once tangible image 11 is scanned, digital image data representing digital image 26 may be electronically transmitted to microprocessor based unit 20 and electronically manipulated. As understood by those skilled in the art, digitized image 26 contains a plurality of pixels, each having a particular color value (either “true or pseudo) for color tangible images 11, such as a color photograph, and intensity and gray scale value for black and white tangible images 11.

A tangible image 11 may be converted to digital image 26 using scanner 24, as discussed above, or alternately, may be “read” directly in a digital format, such as when using a digital camera 28 to take a picture, for example, of a subject, such as a person jogging. The subject image information is directly converted into a digital pixel format within the camera 28 and typically stored on a portable memory card 29 (or in some cases on a diskette-type memory card 23). The digitized image data of the person jogging, for example, may be downloaded into computer 20 using any conventional means, as discussed above, so that the microprocessor of computer 20 has direct and immediate access to the digital image data.

Also, the digital image 26 may be provided by downloading digital image data directly from a memory source, such as floppy disc 23, a memory card 29, an appropriate CD-ROM storage disc 30 which may be read using a CD-ROM reader 32, or the computer's internal hard drive (not shown). Furthermore, digital image 26 may be generated using a commercially available digitizer pad 34 (a tablet) which converts real-time hand drawing movements and pressure information using a stylus 36 into digital data representing a digital image 26. Digital image 26 may also be created using a conventional mouse 38, keyboard 44, or using a monitor such as monitor 21 wherein its screen 22 includes touch-screen functionality. Digital image 26 may be generated using any appropriate input peripheral, as discussed above, used alone or in any combination, and further in combination with an appropriate drawing software, such as Adobe's PhotoShop®, Adobe's Illustrator®, FreeHand®, AutoCad® offered by AutoDesk, and Paint®.

A software program incorporating the digital imaging method of the present invention is capable of accepting and modifying digital image data independent of other software programs. However, the present method may alternatively be incorporated within or may operate in cooperation with various other imaging software programs. Furthermore, as discussed in greater detail below, the present digital imaging software program may be incorporated into the local hard drive memory (or other portable memory medium) of microprocessor based unit 20, used over the Internet 42, or according to one embodiment of the invention, provided in a memory source located in scanner 24 or digital camera 28.

As shown in FIG. 1, display 21 is electrically connected to microprocessor based unit 20 for displaying user-related information associated with the present software. Keyboard 44, mouse 38, digitizer tablet 34 and touch-sensitive screen 22 are also electrically connected to the microprocessor based unit 20 and allow the user to input information and instructions or commands to the operating software. As is well known, keyboard 44, mouse 38, digitizer tablet 34, and touch-sensitive screen 22 may each or in combination be used to control the relative position of a cursor (or selector) 46 located on the display screen 22 and for selecting an item on which the cursor 46 overlays, such as selecting a group of pixels within the digitized image, or selecting an option box from a pull-down menu, or typing in a command.

Regardless how the digital image 26 is created, as discussed above, the digital data making up digital image 26 is preferably inputted into the computer's hard drive or the computer's random access memory (RAM) so that the digital data can be quickly and easily manipulated by the present computer software program. It is preferred that once the digital image 26 is downloaded to the local computer's memory (such as its RAM or its hard drive), the present software program may be operated using only mouse 38 and cursor 46, as is typical with current software programs.

A display controller or video card (not shown) is a hardware circuit board that is used to interpret the drawing commands of a particular software program or instructions conveyed by mouse 38, digitizer 34 or keyboard 44 and drive display 21 so that display screen 22 displays an inputted digital image 26. In operation, the display controller determines which pixels are being drawn, their location, and their color value. The pixels are “drawn” when the video card stores the new pixel values into a two-dimensional array called “a bitmap”. Once this “front end” pixel bitmap is complete, a video “back end” operation of the video controller interprets the bitmap pixel values into their set colors and creates the necessary video signals that drive display 21 so the user can see the “correctly drawn” digital image 26 on display screen 22. The bitmap values are “read” each time the display screen 22 is “refreshed” which, in the case of a typical cathode ray tube (CRT), occurs about 60-80times a second. As understood by those skilled in the art, the color value of each pixel of digital image 26 is typically represented using RGB color space wherein red, green and blue (RGB) component values are used to determine the color “signature” of each pixel. There are generally 256 levels of each of these three colors from which to select in determining the color signature for each pixel. The RGB color information may be stored directly into the bitmap (a “true color system”). In a “pseudo color system” the bitmap information includes color value numbers only and the actual RGB color components that each color value represents must be translated using stored color-lookup tables before each pixel's actual color may be displayed.

An important feature of the present invention is to provide a method to digitally transform an inputted digital image of a tangible photographic image into a painted version of the image, that is to alter the original image so that it looks like it was painted, not merely photographed. The present method turns an otherwise simple photograph into a classical work of art (i.e., a painting). To this end, the present method will include preset pixel-altering criteria which mimic the style of known painters (or painting eras) and thereby introduces the artist's painting characteristics into the digital image. For example, the present method may thereby alter the pixels of a digital image 26 of a photograph of a still life of two pears on a table so that the altered digital image appears like it was painted by the artist Van Gogh. Using the present methods, described below, the user may preselect which artist (such as Van Gogh, Monet, Turner, or even Magritte, etc.) or painting era (such as impressionism, realism, cubism, etc.) he or she wishes his or her inputted digital image 26 to resemble as a painted-version of the original tangible (non-digital) image 11. Using the present methods, the user may quickly and easily convert a simple photograph of a daughter reaching up to pick an apple in a tree into a painting-real digital image that looks like Monet himself painted her using Monet-style impressionism brush strokes.

To simplify the use of a software program performing the present methods, the method will preferably default to one particular type of artist, such as Monet, after which the user may selectively change to other listed artists or painting eras as desired. Once digital image 26 is downloaded to microprocessor based unit 20, the digital image 26 appears on a portion of display screen 22 and the method, by “reading” the bitmap, will become aware of the “color-signature” (i.e., the color value) of each pixel at each pixel address making up the particular digital image 26 which is being displayed on a portion of display screen 22.

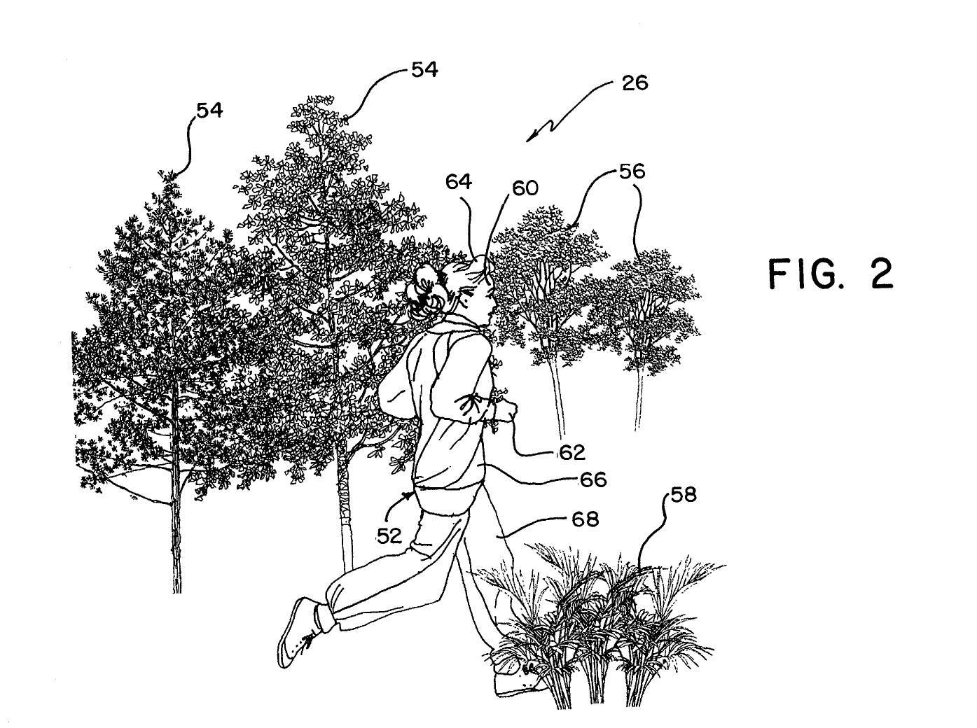

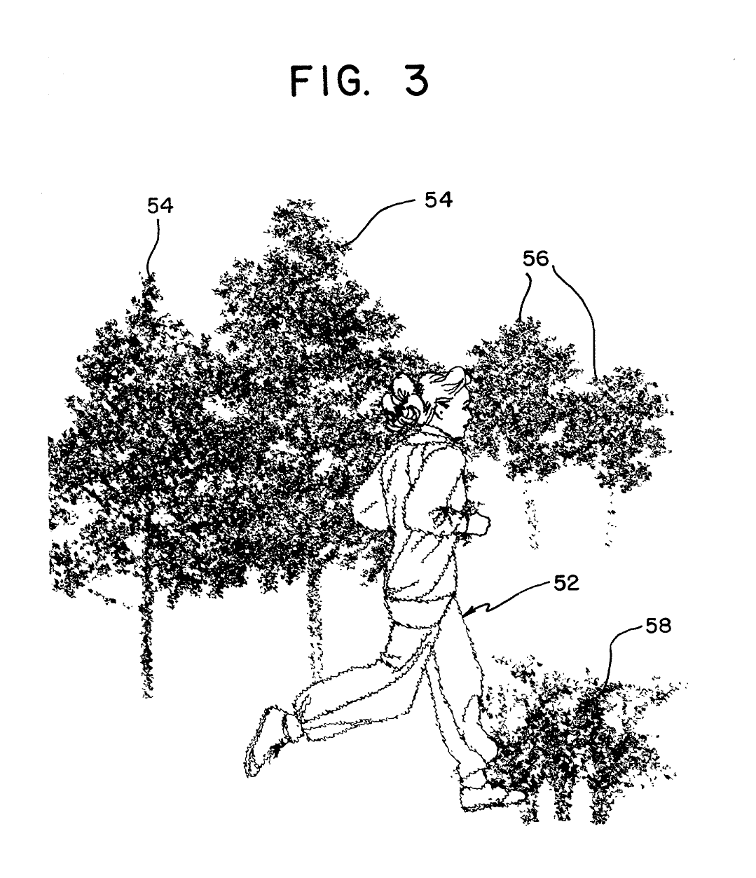

Referring to FIGS. 2 and 3, a digitized image of a person jogging is shown as an illustrative example of the present method. FIG. 2 represents a digital image 26, which may be the digital representation of a tangible image 11 (discussed above) or a subject (such as when using a digital camera 28). FIG. 3 represents an altered, texture-enhanced digital image 50. The digital image 26 in this example includes a woman 52 jogging in the foreground in front of two trees 54 located mid-ground and two other smaller trees 56 located in the background. Finally, short ferns 58 are located in the immediate foreground. The woman 52 has fair skin (i.e., her face 60 and her hand 62), and blond hair 64. She is wearing a dark bluejacket 66 and a light blue pair of jogging pants 68.

According to the invention, after the digital image 26 has been inputted into the computer 10, the software program following the present method “reads” the bitmap which has been “loaded” with the digital image 26 and automatically searches and isolates pixels having a common color signature or color value. Pixel commonality may include groups of pixels which have color component values that are within a default RGB color value range, e.g., up to 30 levels of red, green or blue. The process used with the present method of reading the bitmap to locate pixels of common color value may be similar to the “magic wand” feature of PhotoShop®.

In the example shown in FIGS. 2 and 3, the bitmap of the digital image 26 (FIG. 2) will reveal that the pixels making up the dark blue jacket 66 of the image all have a common color signature (all RGB values are within 30 color levels within each color component, red, green, and blue), or in other words, all of the dark blue jacket pixels appear to have a similar shade of the color blue (within a preset, but changeable color range). The “jacket” pixels will define one “working region” of the digital image.

Similarly, the pixels making up the woman's light blue jogging pants will be read as having a common color signature and will therefore form another working region of the digital image. The woman's face 60 and her hand 62 will form a third working region because of their pixel commonality (e.g., skin tone), while the mid-ground trees 54, the background trees 56, and the foreground ferns 58 may all be interpreted by the present method as being additional and separate “working regions” of the digital image 26.

Although it has been described that the working regions of the digital image are defined by detecting color commonality among the pixels of the image, the working regions may be similarly defined by comparing relative brightness of pixels and/or natural texture of pixels, or selected groups (testing regions) of pixels of the image. Regions of an image may differ in their own natural texture, such as an image representation of grass compared to that of clouds, or trees. The differing textures may be detected and used to separate grass regions from tree regions of the image. It may be helpful to use both texture and color variations of an image to help define the working regions of an image, for example, green and smooth texture could indicate a green shirt, whereas the same color green but with rough texture could represent grass. Any combination of color, texture, and brightness may be used to help define accurate working regions of an image.

After all the working regions are defined in the example image shown in FIG. 2, the method will apply a predetermined texture to each working region using predetermined criteria which vary according to the selected artist, the size of the working regions, the color of each working region, and whether a particular working region is defined as a foreground image, as described below. Regardless, it is likely that a different texture will be applied to each working region, similar to a real painting wherein the particular brush strokes applying paint will vary depending on the style of painting, the type of paint, (water colors, oils, etc.), the size, shape, and importance of the various objects or subjects throughout the painting, and the desired mood the painter wants the painting to instill when viewed. Returning to the example of FIGS. 2 and 3, after the present method applies a different texture to each defined working region the image of FIG. 2 begins to resemble a painting, which is illustrated in FIG. 3. As shown in FIG. 3, the mid-ground trees 54 have a different texture to the woman 52 and the texture to the foreground ferns 58 is different to the background trees 56. By varying the texture applied to each working region, the altered image acquires depth, which helps the realism of the painting effects.

According to one embodiment of the present invention, once the different working regions of a particular digital image are determined, the method automatically introduces an electronic texture to each working region, preferably a different type of texture or at least a different intensity of the same texture to each working region. If the textures are to represent the brush strokes of a painting, the present method will vary each pixel color value, depending on the particular artist selected by the user (or using the default-artist setting), within each working region to mimic the applied brush stroke within that particular working region. The default settings and the artist's brush-stroke information for select artists is provided by the method and stored either locally in an appropriate database formed in local memory (e.g., hard drive) or downloaded or otherwise accessed when required over the Internet from a remotely located database.

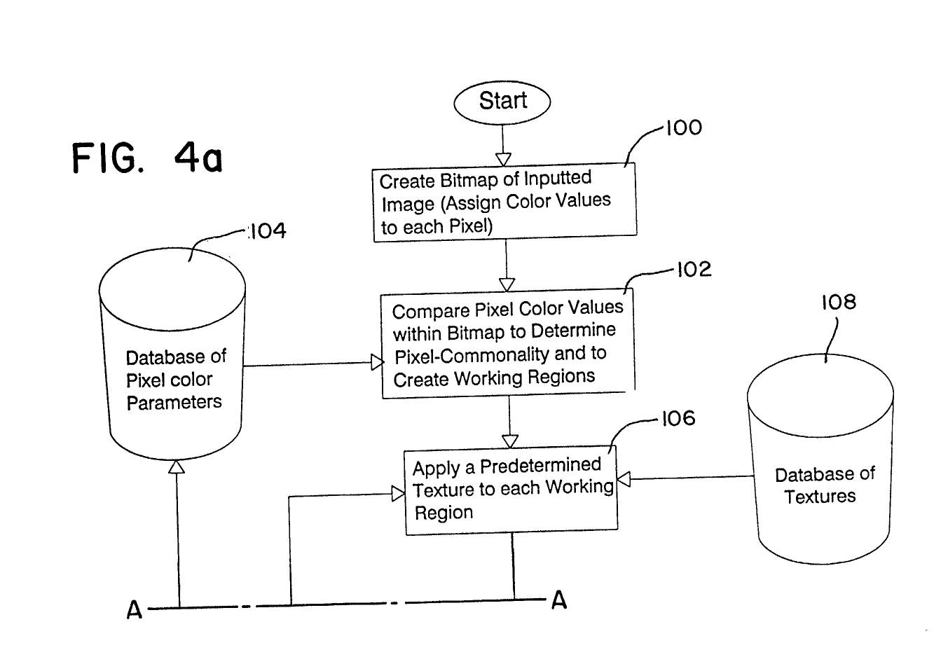

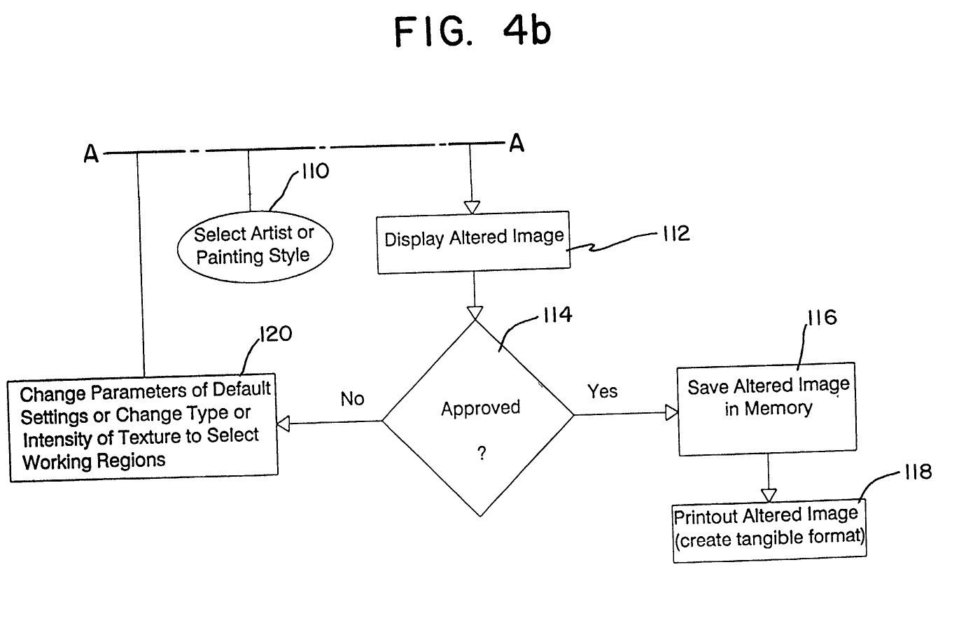

With reference to FIG. 4 and according to this embodiment of the invention, a user first inputs an image into the computer. At step 100, the computer creates a bitmap of the inputted image and assigns color values to each pixel in a conventional manner. At step 102, the method “reads” the newly created bitmap and determines pixel commonality, as described above, using predetermined pixel color ranges (such as within a color value of 30 of each RGB color component) to create different “working regions” of the image. The pixel color ranges may be stored in an appropriate accessible database 104. At step 106, a predetermined texture is applied to each working region according to a database 108 of textures. The user may input at 110 which type of artist or painting style he or she wishes to apply to the inputted image. At step 112, the method displays the altered image (the image having applied textures to each working region). If the user (viewing the displayed altered image) likes the effects to the image as decision step 114, he or she may then cause the method to save the altered image in an appropriate memory at step 116 to be later printed out at step 118. If the user does not like the displayed altered image, he or she may cause the method to automatically change (by a predetermined amount or by a random amount, or by values offered by the user) the parameters of the default settings used to determine pixel commonality at step 120, after which the method will return to step 102 and re-determine new working regions using the new pixel-commonality parameters (such as a color range value of 40 for each RGB color component). The process of FIG. 4 will continue until the user sees an altered image he or she likes.

According to another embodiment of the invention, the present method automatically determines the relative area (planar size) of each working region and applies a different texture or effect accordingly. For example painters generally use smaller and thinner brush strokes when painting smaller elements of a painting to achieve detail. To this end, the present method automatically applies a first “fine” electronic texture (by changing the color values of select pixels within a working region) which would convey small brush strokes to any working regions having a small measured area. Similarly, a more “rough” electronic texture which would convey wider and longer and thicker brush strokes would be electronically applied (again by varying the color values of selected pixels) to larger working regions.

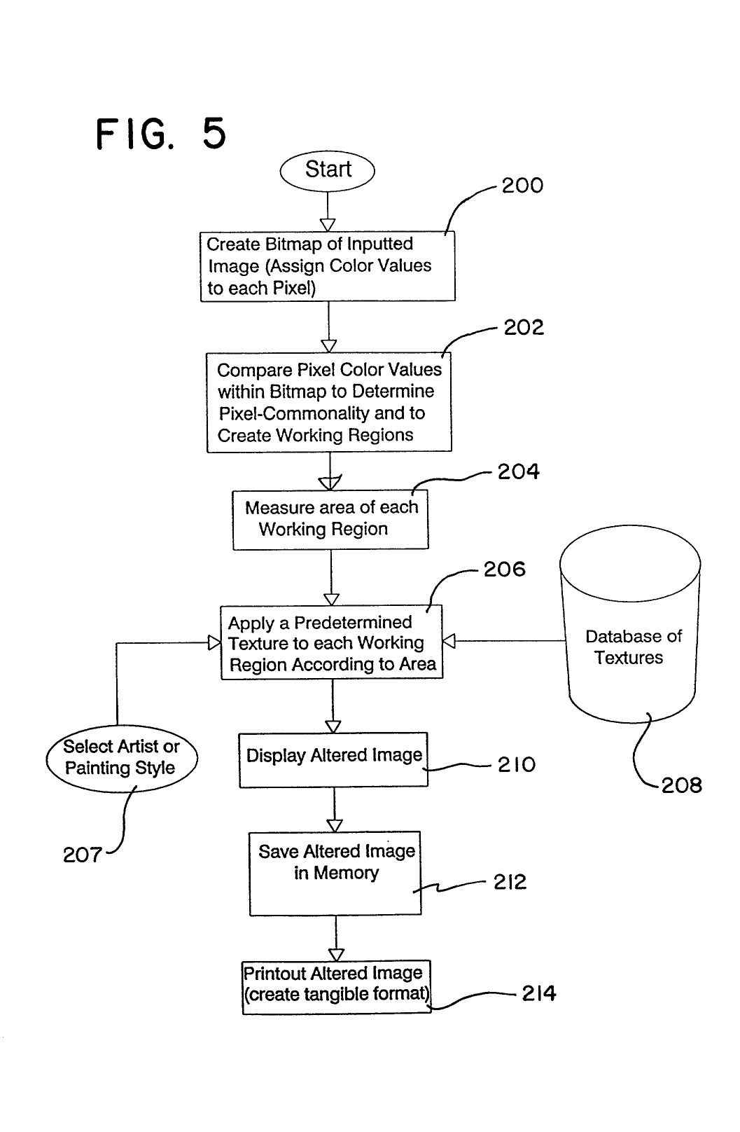

Referring to FIG. 5, after the user inputs an image to be altered the method according to this embodiment of the invention will, at step 200, create a bitmap of the inputted image and assign a color value to each pixel. At step 202, the method compares the color values within the bitmap to determine pixel-commonality and thereby create working regions. At step 204, the method measures the area of each working region using conventional pixel-counting techniques. At step 206, the method applies a texture to each working region according to its measured area and the selected artist (as selected by the user at input 207) from textures stored in database 208. At step 210, the method displays the altered image (i.e., the image having the applied textures). At step 212, the method stores the altered image information in an appropriate memory location to be later printed out at step 214.

According to yet another embodiment of the invention, once all of the working regions are determined (or as each is determined), the present method highlights each working region, using any appropriate technique. One “highlighting” technique includes outlining each working region with a line having a predetermined thickness and defined by temporarily changing overlaid pixels with contrasting color values so that they may be readily seen against the color of the particular working region and adjacent regions (for example, if a blue region lies next to a red region, the program would pick a boundary line color that would contrast both regions, such as a green or black color). Also, the boundary line may be provided with multiple colors which change or appear to move along the boundary line with time to help the user see the boundary lines defining each working region of the digital image. According to this embodiment of the invention, the present method allows a user to preview the digital image 26 after the working regions have been defined yet before the various textures have been applied. In doing so, the user may use cursor 46 and mouse 3 8 to select particular highlighted working regions in response to questions asked by the program, such as: “Please ‘click’ to select the working regions which represent the foreground subject(s) of the image”. In the example shown in FIG. 2, the user would select the working regions which represent the woman, her face 60, hair 64, hand 62, jacket 66 and pants 68. Once the present method learns the “depth” information of a particular digital image (which adjacent working regions represents the subject), the present method may once again automatically applies different textures to each working region, but now may apply a common texture to the working regions having “common depth”, i.e., those working regions which represent a common subject of the digital image. This selectively application of common texture helps create a realistic painting effect of the original digital image 26.

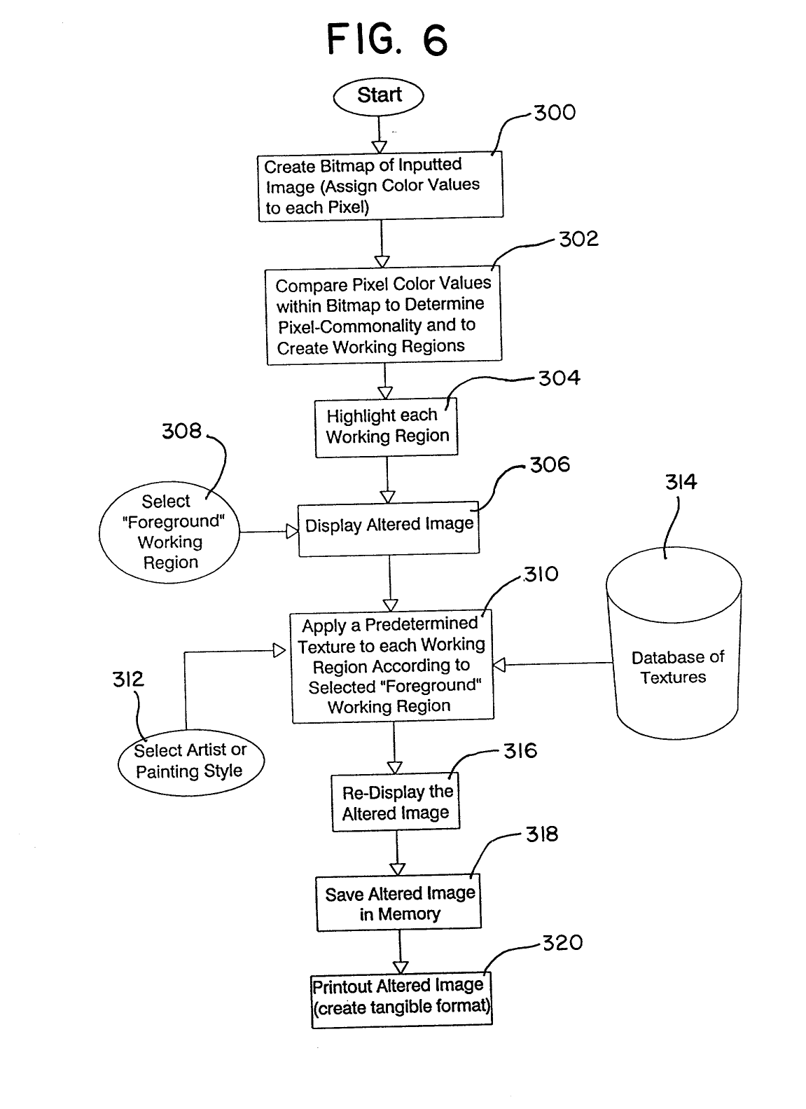

Referring to FIG. 6, after the user inputs an image to be altered the method according to this embodiment of the invention will, at step 300, create a bitmap of the inputted image and assign a color value to each pixel. At step 302, the method compares the color values within the bitmap to determine pixel-commonality and thereby create working regions. At step 304, the method highlights each working region, preferably all at the same time. At step 306, the method displays the highlighted working regions so that the user may select a foreground working region at input 308. At step 310, the method applies a texture to each working region according to selected artist (as selected by the user at input 312) and the selected foreground working region, from textures stored in database 314. At step 216, the method re-displays the altered image (i.e., the image having the applied textures). At step 218, the method stores the altered image information in an appropriate memory location to be later printed out at step 220.

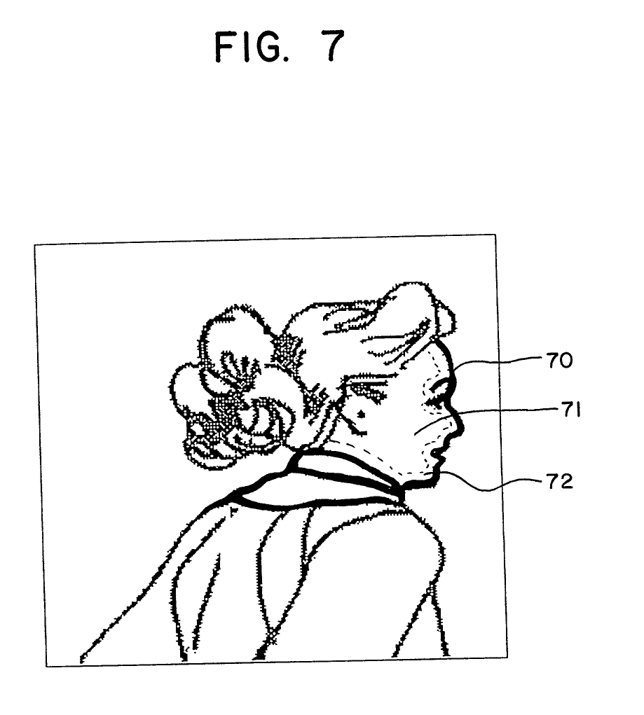

As shown in FIG. 7 and according to yet another embodiment of the present invention, since the edges or boundary lines 70 of each working region 71 are known (in the bitmap), all pixels located adjacent to the boundary lines (within a predetermined range) are re-defined as edge regions 72 (the term edge region is used to explain the following realistic edge-brush stroke according to one embodiment of the invention—the term simply means the area or region that is close to a boundary line within a specified working region). To further mimic the real-life brush strokes of an artist into a digital image 26, the pixels located within each edge region 72 are altered to convey a “directional brush stroke” which is applied to the bitmap (i.e., the digital image) according to the direction (or shape) of the particular boundary line, and the type of artist selected by the user. For example, if Rembrandt was selected as the artist, the present method, according to this embodiment of the invention, would introduce an electronic texture within the edge regions 72 which would convey directional brush strokes that generally follow in the direction or path of the adjacent boundary line 70, creating a smooth, well defined “realistic” transition between two working regions (two adjacent regions of different color shades). In contrast, as another example, if Monet was selected as the artist, the texture applied within the edge regions would convey directional brush strokes which would appear at an angle with respect to the boundary line 70, and in some cases the brush strokes may actually overlap from one edge region 72 to another edge region 72 of an adjacent working region, creating a diluted, soft, and “impressionistic” transition from a working region of a first color shade to an adjacent one of a different color shade.

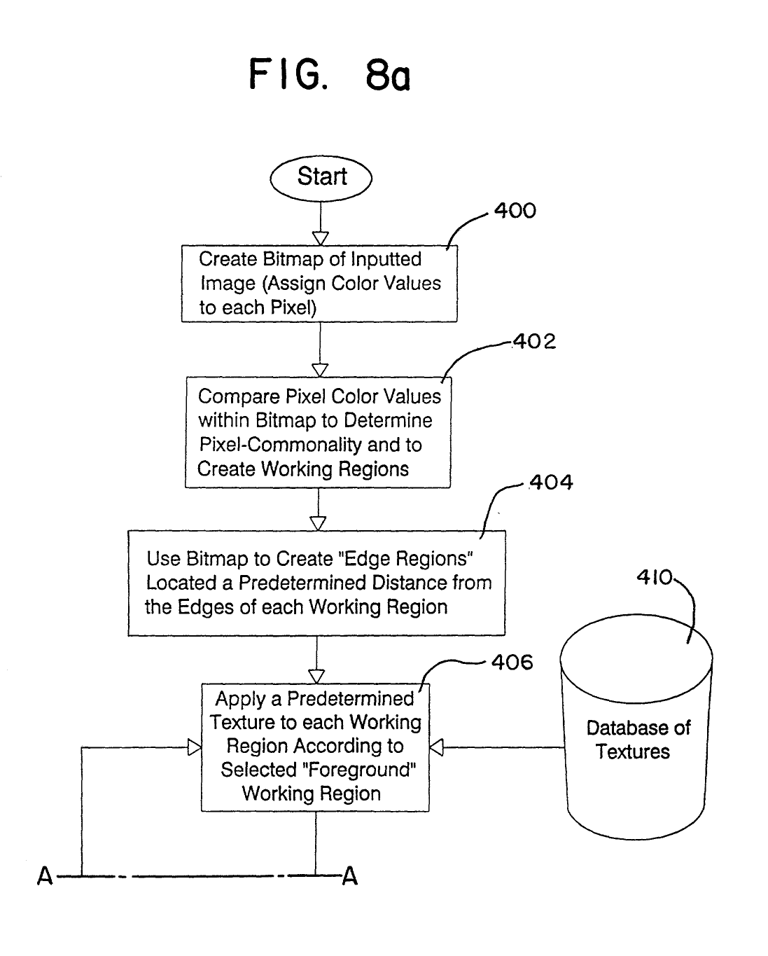

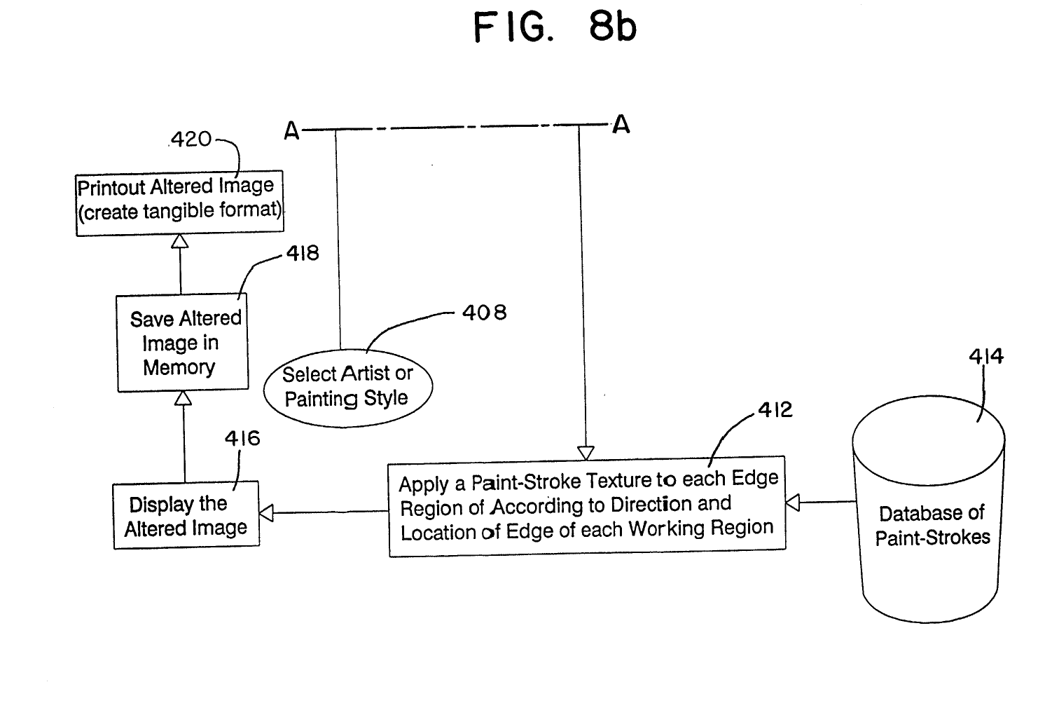

Referring to FIG. 8, after the user inputs an image to be altered the method according to this embodiment of the invention will, at step 400, create a bitmap of the inputted image and assign a color value to each pixel. At step 402, the method compares the color values within the bitmap to determine pixel-commonality and thereby create working regions. At step 404, the method uses the bitmap to define edge regions 72. The edge regions 72 follow the shape of the corresponding boundary line 70 of the particular working region and have a pre-determined thickness which may vary according to various parameters such as measured area of the working region (or perhaps the selected artist or painting style). At step 406, the present method applies a texture to each working region according to selected artist (as selected by the user at input 408) and the selected foreground working region, from textures stored in database 410. At step 412, the method applies a predetermined paint-stroke to each edge 70 region according to the particular direction and location of the boundary line 70 of the particular working region. The paint-stroke information regarding the type, size, shape, “weight” and direction of each paint-stroke and how to apply each such paint-stroke within the edge region according to the size and shape of the edge region and the direction of the boundary line 70 and according to the selected artist is provided in a database of paint-strokes 414. At step 416, the method displays the altered digital image showing texture variations in both the edge regions and the working regions throughout the image. The altered image may be stored in an appropriate memory at step 418 and printed out on paper (or any other tangible medium) at step 420.

The present method would apply a predetermined texture to each working region and edge region, according to the painting era or particular artist selected, the measured area of each working region, and any working regions that are manually grouped together by the user as desired. The preferred electronic brush stroke textures applied to the digital image according to the present method preferably vary in shape, size, depth or “weight” (introducing electronic shadowing effects to each brush stroke to mimic a thickness to the “paint”, to give the illusion of a pallet-knife effect), starting and ending width, direction of stroke with respect to boundary information or otherwise (more vertical, or more horizontal), strokes created by different types of real-life brushes, such as strokes created using a “fan” type brush or a straight thick brush or a fine detailed brush, or even a wash effect using a sponge applicator. Furthermore, the pixels within each working region may be altered in such a manner to convey water-color paintings wherein the boundary lines between working regions may be detected and changed to a white color to mimic a water-color artist's painting technique to prevent wash-through of adjacent colors or regions. Alternatively, an electronic “wash-through” effect may be introduced in a controlled manner across all or selected boundary lines between adjacent working regions to convey a “color-wash” or “bleeding” effect commonly used by water-color artists in the real world.

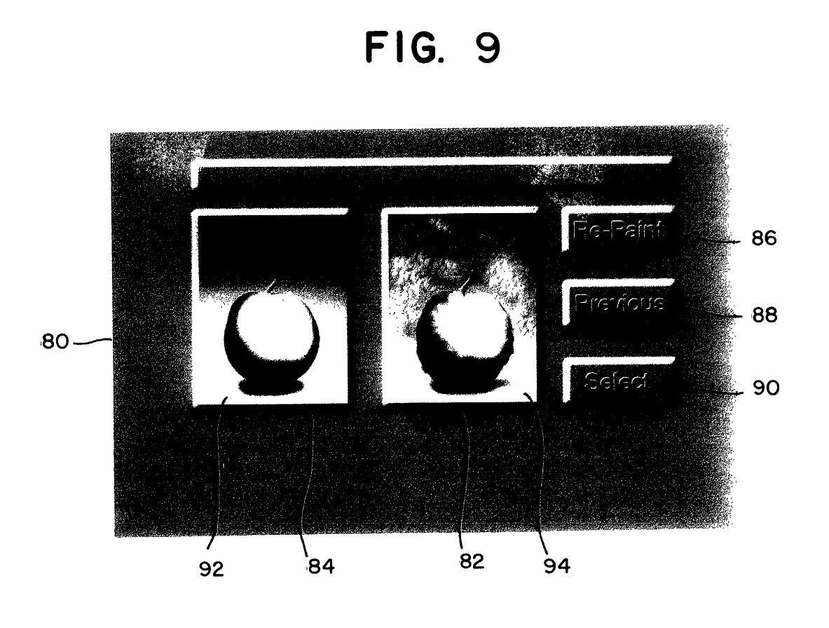

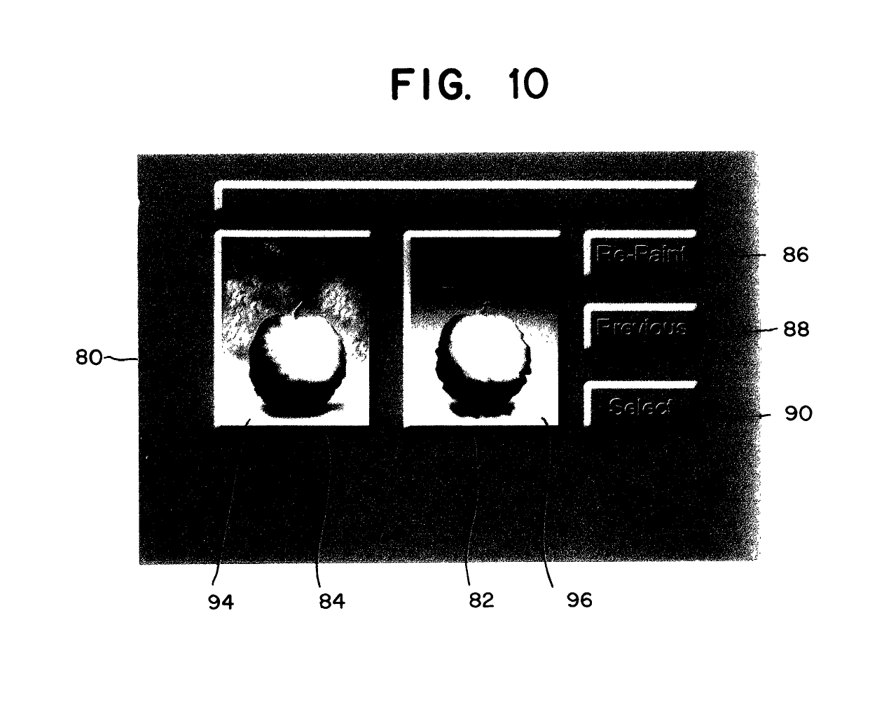

According to yet another embodiment of the present invention, after the user loads a particular digital image into the computer, the present method will automatically detect all working regions, apply a predetermined texture to each region following preset default criteria, as discussed in earlier embodiments, and display the altered image for the user's review. Referring to FIGS. 9 and 10, the method according to this embodiment electronically displays a user interaction window 80 on the display screen 22. The window 80 preferably includes a first review panel 82, a second review panel 84 and at least a control button 86 (which may be selected using mouse 3 8 and cursor 46) which is labeled “RE-PAINT”, and may include another control button 88 labeled “PREVIOUS” and a third control button 90 labeled “SELECT”. In operation of this embodiment, the original digital image 92 is first displayed in the first review panel 82 and the method automatically applies predetermined texture, as described above, thereby creating a first altered image (or a first “painting” ) 94. The first painting 94 is displayed in the first review panel 82, and the original image 92 is automatically transferred to the adjacent second display review panel 84, as is illustrated in FIG. 9.

If the user likes the first painting 94 shown in the first review panel 82 (as readily compared with the “previous” original image 92 presented in the second review panel 84), the user may use the mouse 38 and cursor 46 in a conventional manner to select the “SELECT” button 90, at which point the present method will save the altered “first painting” 94. However, if the user does not like the first painting attempt, he or she may select the “RE-PAINT” button 86, at which point, the present method will change predetermined criteria, such as the level or intensity of the applied textures, the type of texture used, the use of edge regions and edge brush strokes, the particular artist, the particular brush strokes used, the painting era or type, or any of the criteria used to define either the working regions or the edge regions, and re-alter the original image 92 or the first painting 94 (preferably the original image will be “re-painted”).

Once a second painting 96 (of the original image 92) is completed, the method will display the second painting 96 within the first review panel 82, at which point the first painting 94 will be automatically transferred to the second review panel, and the original image 92 will preferably be temporarily stored in memory and removed from view. The user may now simply compare the first and second paintings shown on the screen. The user may press the “SELECT” button 90 to save the second painting 96 shown in the first review panel 82, or may press the “RE-PAINT” button 86 to have the present method repeat the altering process by again changes one or more altering parameters, as discussed above, to create a third painting (not shown), which would be displayed in first review panel 82, moving the second painting 96 over to the second review panel 84, and transferring the first painting into temporary RAM storage (out of view). Finally, the user may “go back” to view the first painting 94 with the original image 92, by selecting the “PREVIOUS” button 88. This would cause the present method to recall the original image 92 from RAM memory and move the second painting 96 into RAM memory and off the screen.

One advantage of the present method, illustrated in FIGS. 9 and 10 is that the user may quickly and easily have an original image altered in a progressively varying manner until he or she likes a particular version. The method may simply follow a predetermined sequence of varying parameters to provide painting-like images, each of which appears different from a previous one. The user doesn't have to learn any complex digital imaging programs and manually apply each and every effect to create a “painting” from a photograph. He or she can create a desired painting effect by simply pressing a button. The invention may continuously “repaint” the same digital image, as requested by the user, each time varying one or more parameters or criteria in a bracketing manner, until the user finds a desired “combination” of digital imaging variables.

Once a particular digital image 26 is successfully altered using the present program, the user may transmit the altered digital image data to a conventional printer 98 (see FIG. 1) to print the altered digital image onto a tangible medium, or to a conventional and appropriate memory location, such as the computer's hard drive, an optical CD, magnetic storage discs, or sent over the Internet directly to a web-site, or included with (or as an attachment to) an E-mail (electronic mail sent over the Internet 42).

Also, the user may send the altered digital image data over the Internet to a pre-established location which may print the electronic “painting” onto a tangible medium, such as canvas, paper, or clothing or simply display the altered image (the “painting”) at a web site on the Internet.

A software program including the methods of the present invention may also be located at a remote program site and may be accessed using the Internet in a controlled manner by a user at a local site. In such instance, the user would digitize a tangible image to a digital image and transmit the digital image to the program site. The software program, located at the remote program site would alter the digital image, according to instructions by the user and would return the altered digital image over the Internet to the user's local site and/or printout the altered digital image onto a tangible medium, as described above.

The above-described methods may operate alone or in combination. A programmer may create an appropriate computer-readable set of instructions (a program) incorporating the present methods so that the method may operate by a computer. Any appropriate computer language may be used to communicate with the computer, including “C”, “C++”, COBAL, and APL, or others as understood by programmers.

Defining the Electronic Effects

The methods of the invention described above are all intended to alter a digital image to look like it was painted by a particular artist or painting era. The above-described methods may use brush-stroke information which has been derived from actual paintings of selected artists and paintings from selected eras. An actual painting, for example, may be scanned using a laser scanner to allow a computer to “read” the brush-strokes the painter used to create the painting. The scanned graphic information of the subject painting is stored in electronic memory and digitally manipulated to extract the particulars of the painting strokes used throughout the subject painting. The manipulation step may include an averaging of the stroke details so that a generic pattern or texture may be electronically generated within the computer wherein the generated pattern or texture generally mimics the painting strokes of the particular artist. After many paintings are “read”, a pattern of the painting style of each painter may be established. The resulting brush-stroke patterns may be used as a guide as various textures are electronically applied to a digital image, ad described above.

What is claimed is:

1. A method for introducing textural effects to various working regions of an inputted digital image, comprising the steps of:
creating a bitmap of said inputted image wherein each pixel of the bitmap has a color value;
comparing the color values of each pixel within the bitmap to located pixels having common color values,
defining working regions of said image according to pixels of common color values;
applying a predetermined texture to each of said defined working regions according to predetermined criteria to create an altered image; and
displaying said altered image.
